(19) United States
(12) Patent Application Publication
(10) Pub. No.: US 2008/0316782 A1
(43) Pub. Date: Dec. 25, 2008

(54) SYSTEM AND METHOD FOR PRODUCTING ANHARMONIC MULTI-PHASE CURRENTS

(75) Inventors: Irving Dardik, Califon, NJ (US); Shaul Lesin, Meitar (IL); Alex Shapiro, Beer-Sheva (IL); Michael Khavkin, Beer-Sheva (IL); Arkady Kapusta, Beer-Sheva (IL); Herman Branover, New York, NY (US); Boris Mikhailovich, Beer Sheva (IL); Boris Tilman, Beer-Sheva (IL); Ephim Golbraikh, Beer-Shiva (IL); IIya Zilberman, Meitar (IL)

Correspondence Address: GREENBERG TRAURIG, LLP, 2101 L Street, N.W., Suite 1000, Washington, DC, 20037, US

(73) Assignee: Energetics, Inc., Califon, NJ (US)

(21) Appl. No.: 12/122,760

(22) Filed: May 19, 2008

Related U.S. Application Data
(60) Provisional application No. 60/945,116, filed on Jun. 20, 2007.

(51) Int. Cl. H02M 7/44

(52) U.S. Cl. 363/95

(57) ABSTRACT

A system and method for producing anharmonic multi-phase currents wherein the harmonic component of an inverter is filtered and superimposed with a series of control pulses to create a control signal. The control signal is fed back to the inverter, causing the inverter to produce anharmonic multi-phase currents.

This application claims priority from Provisional U.S. Patent Application Ser. No. 60/945,116, filed Jun. 20, 2007, which is hereby incorporated by reference in its entirety.

This application includes material which is subject to copyright protection. The copyright owner has no objection to the facsimile reproduction by anyone of the patent disclosure, as it appears in the Patent and Trademark Office files or records, but otherwise reserves all rights.

### FIELD

The instant disclosure relates to the field of electromagnetic field generation as applied to technological processes.

### BACKGROUND

Electromagnetic fields are widely used to intensify technological processes, particularly metallurgical processes. Traditional applications use electromagnetic fields that vary harmonically with time. However, anharmonic magnetic fields excited by anharmonic currents are being increasingly used in metallurgical processes.

There are several known methods of producing anharmonic currents. One utilizes a switching power supply, such as the model IX 15 programmable power supply manufactured by California Instruments of San Diego, Calif., having a maximum power output of 15 kW, to produce anharmonic currents. Such switching power supplies are typically expensive, and their power rating is typically insufficient for use in industrial scale applications.

Another method uses the superposition of the harmonic currents from two or more inverters to produce anharmonic currents. The application of this method is limited because care must be taken to protect the inverters from mutual impact.

### SUMMARY

Accordingly, the instant disclosure is directed to a system and method for producing anharmonic multi-phase currents that substantially obviates one or more of the problems due to limitations and disadvantages of the related art.

Additional features and advantages of the system and method for producing anharmonic multi-phase currents will be set forth in the description which follows, and in part will be apparent from this disclosure, or may be learned by practice of the system and method for producing anharmonic multi-phase currents. The objectives and other advantages will be realized and attained by the structure particularly pointed out in this written description, including any claims contained herein and the appended drawings.

The instant disclosure describes a method of producing anharmonic multi-phase currents based on a multi-phase system of harmonic currents generated using pulse-width modulated impulse voltages involving an external impulse impact leading to the formation of an anharmonic current shape. In one embodiment, the pulse-width modulated impulse voltages may be characterized by a specified periodicity. In another embodiment, the shapes of the external impulse impact may affect the spectrum of the output current.

The instant disclosure further describes a system for producing anharmonic multi-phase currents which comprises a source of harmonic multi-phase currents (e.g., an inverter) and a function generator, wherein the function generator causes the inverter to generate anharmonic multi-phase currents of a specified shape. In an embodiment, the function generator may further comprise a control pulse generator unit and a synchronization unit, the synchronization unit comprising a sensor and a filter. In an embodiment, the inverter may further comprise a computing unit, which may be connected to the control pulse generator unit, and a power unit.

Some embodiments provide a system for producing anharmonic multi-phase currents comprising an inverter, the inverter having an input and an output; and, a function generator, the function generator capable of sampling the inverter output and generating a control signal, the control signal, when applied to the inverter input, causing the inverter to output anharmonic multi-phase currents.

In some embodiments, the function generator further comprises a low-pass filter, the low-pass filter producing a filtered signal, the filtered signal comprising the harmonic component of the inverter output, and wherein the control signal comprises the superposition of one or more pulses and the filtered signal.

In some embodiments, at least a subset of the pulses are square waves. In some embodiments, at least a subset of the pulses are triangle waves.

In some embodiments, the period of the control signal is less than the period of the harmonic component of the inverter output. In some embodiments, the period of the control signal is less than half of the period of the harmonic component of the inverter output.

Some embodiments provide a system for producing anharmonic multi-phase currents comprising: an inverter, the inverter having an input and an output; and, a function generator, the function generator capable of generating a control signal, the control signal comprising one or more pulses, the control signal, when applied to the inverter input, causing the inverter to output anharmonic multi-phase currents.

Some embodiments provide a method for producing anharmonic multi-phase currents, the method comprising: filtering an inverter output with a low-pass filter to produce a filtered signal, the filtered signal comprising the harmonic component of the inverter output; generating a control signal, the control signal comprising the super position of one or more pulses and the filtered signal, the control signal capable of causing an inverter to output anharmonic multi-phase currents; and, applying the control signal to an inverter input, thereby causing the inverter to produce anharmonic multi-phase currents.

Some embodiments provide a method for producing anharmonic multi-phase currents, the method comprising: generating a control signal, the control signal comprising one or more pulses, the control signal capable of causing an inverter to output anharmonic multi-phase currents; and, applying the control signal to an inverter input, thereby causing the inverter to produce anharmonic multi-phase currents.

It is to be understood that both the foregoing general description and the following detailed description are exemplary and explanatory and are intended to provide further explanation of the disclosed system and method for producing anharmonic multi-phase currents.

### BRIEF DESCRIPTION OF THE DRAWINGS

The accompanying drawings, which are included to provide a further understanding of the disclosed system and method for producing anharmonic multi-phase currents, are incorporated in and constitute a part of this specification. The drawings illustrate various embodiments and, together with the description, serve to explain the principles of at least one embodiment of the disclosed system and method for producing anharmonic multi-phase currents.

In the drawings:

FIG. 1 is a functional diagram illustrating an exemplary embodiment whereby anharmonic, multi-phase currents can be created.

FIG. 2 is a functional diagram illustrating an exemplary embodiment whereby anharmonic, multi-phase currents can be created.

FIG. 3 is a functional diagram illustrating an exemplary embodiment whereby anharmonic, multi-phase currents can be created.

FIG. 4 is a functional diagram illustrating an exemplary embodiment whereby anharmonic, multi-phase currents can be created.

FIG. 5 is a functional diagram illustrating an exemplary embodiment whereby anharmonic, multi-phase currents can be created.

FIG. 6 is a graphic representation of inverter output current at various input impact periodicities and forms (e.g., rectangular) according to an embodiment.

FIG. 7 is a graphic representation of inverter output current at various input impact periodicities and forms (e.g., triangular) according to an embodiment.

### DETAILED DESCRIPTION

Reference will now be made in detail to embodiments of the disclosed system and method for producing anharmonic multi-phase currents, examples of which are illustrated in the accompanying drawings.

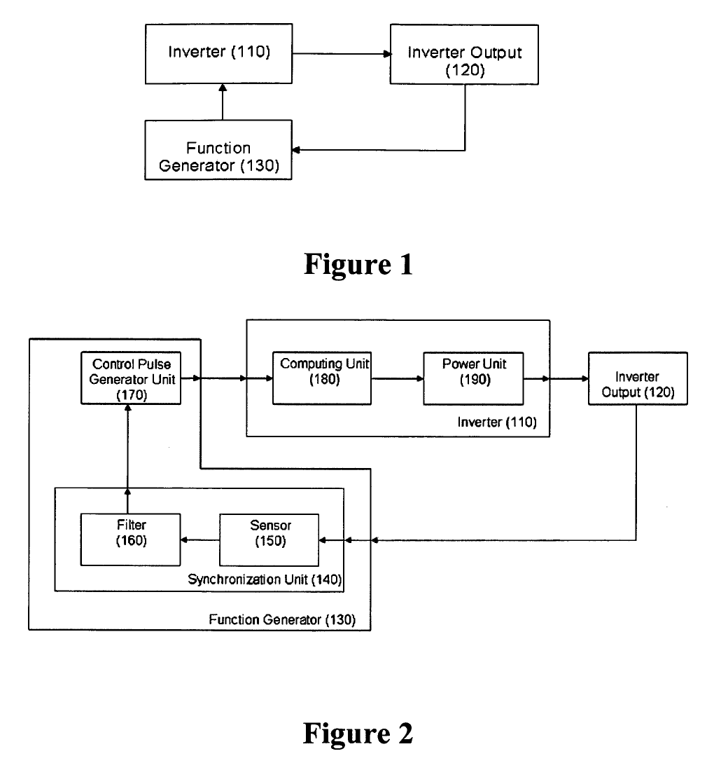

In various embodiments, as illustrated in FIG. 1, the system and method utilizes at least one multi-phase harmonic current source, an inverter 110, to produce anharmonic multi-phase currents. Although described herein as employing an inverter, alternative multi-phase harmonic current sources can be substituted therefore without departing from the spirit or the scope of the invention.

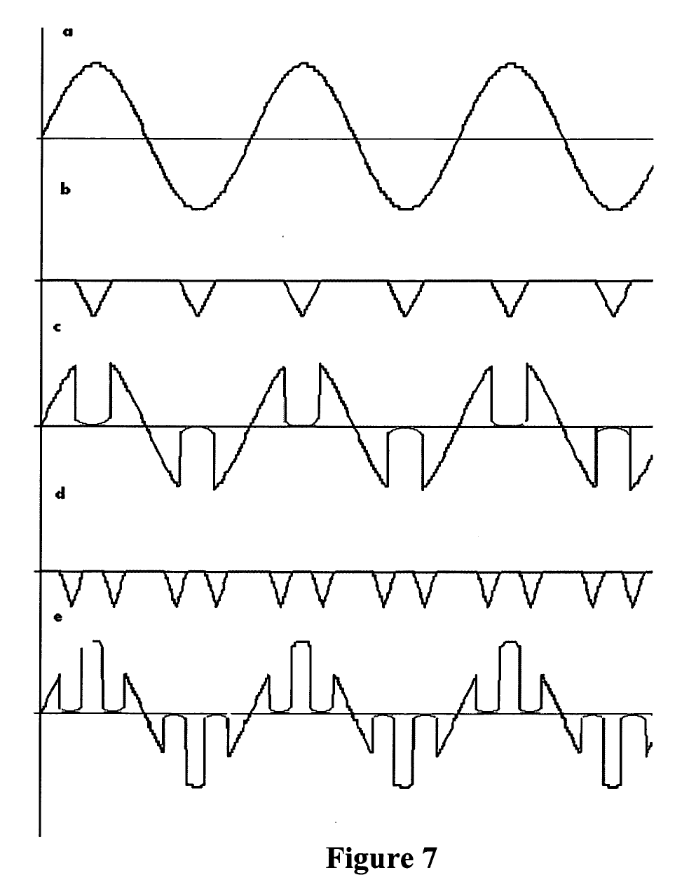

At startup, inverter output 120 typically comprises multi-phase harmonic currents such as those illustrated in FIGS. 6a and 7a. The inverter output 120 is sampled by a function generator 130, which outputs pulses of a specified shape such as, e.g., square waves or triangle waves. This impulse signal is an input to the at least one inverter 110. In some embodiments, the impulse signal has a period less than the period of the multi-phase harmonic currents and can have a square shape, as illustrated in FIGS. 6b, 6d, or a triangular shape, as illustrated in FIGS. 7b, and 7d, such that it will cause the at least one inverter output 120 to be comprised of multi-phase anharmonic currents as shown in FIGS. 6c, 6e, 7c, and 7e respectively.

In some embodiments, as illustrated in FIG. 2, inverter 110 may comprise a computing unit 180 and a power unit 190. By way of example, without limitation, suitable inverters may include the VAT-2000 inverter available from GE Power Controls of Cheshire, United Kingdom. The VAT-2000 provides inputs for controlling the inverter output frequency via either voltage (using the FSV contact) or current (using the FSI contact).

In some embodiments, function generator 130 further comprises a synchronization unit 140 and a control pulse generator unit 170. The synchronization unit 140 samples the inverter output 120 and provides a synchronization signal to the control pulse generator unit 170.

In some embodiments, synchronization unit 140 may further comprise a sensor 150 and a filter 160. Sensor 150 measures the signal from the inverter output 120. Filter 160 acts as a low-pass filter to extract the harmonic component of the output signal of sensor 150. By way of example, without limitation, suitable sensors may include the 1146A AC/DC Current Probe manufactured by Agilent Technologies of Santa Clara, Calif.

Control pulse generator unit 170 generates a control output signal such that computing unit 180 generates a pulse-width modulated signal that induces the power unit 190 of inverter 110 to generate anharmonic multi-phase currents at the inverter output 120.

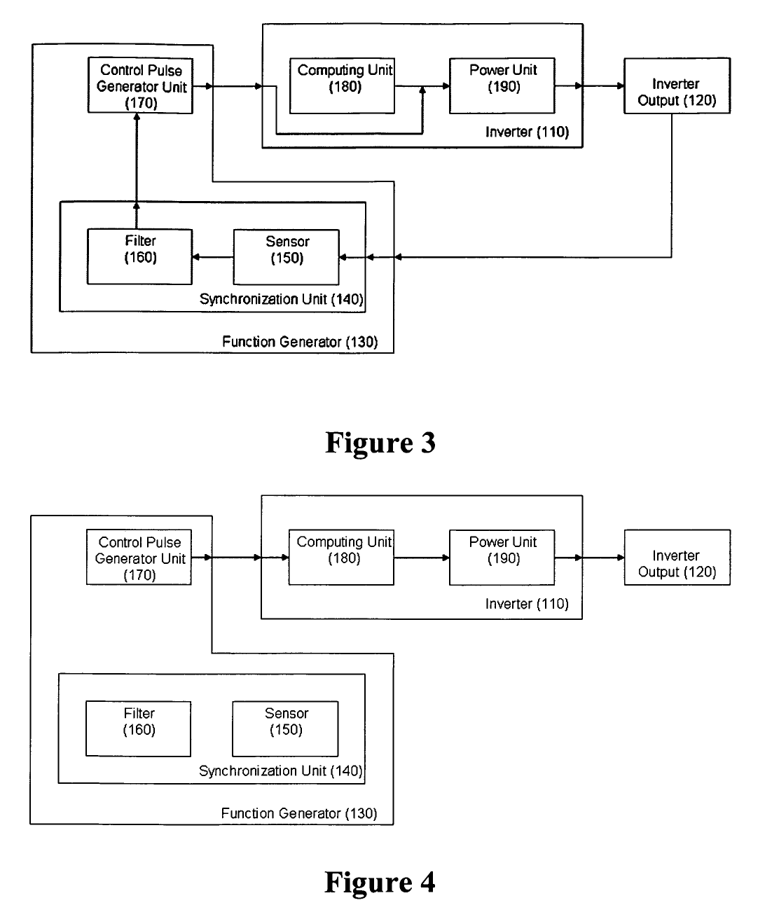

In some embodiments, as illustrated in FIG. 3, the synchronization unit 140 samples the inverter output 120 and provides a synchronization signal to the control pulse generator unit 170. Control pulse generator unit 170 provides pulses having a period less than the period of the multi-phase harmonic currents of a specified shape to power unit 190, and computing unit 180 generates a harmonic output control signal. The superposition of the pulses of a specified shape and the harmonic output control signal induces the power unit 190 of inverter 110 to generate anharmonic multi-phase currents at the inverter output 120.

In some embodiments, as illustrated in FIG. 4, the synchronization unit 140 is idle and the control pulse generator unit 170 operates in a self-sustained oscillator mode. By way of example, without limitation, a suitable control pulse generator unit 170 may include the model 166 function generator manufactured by Wavetek. Control pulse generator unit 170 generates a control output signal having a period less than the period of the multi-phase harmonic currents such that computing unit 180 generates a pulse-width modulated signal that induces the power unit 190 of inverter 110 to generate anharmonic multi-phase currents at the inverter output 120.

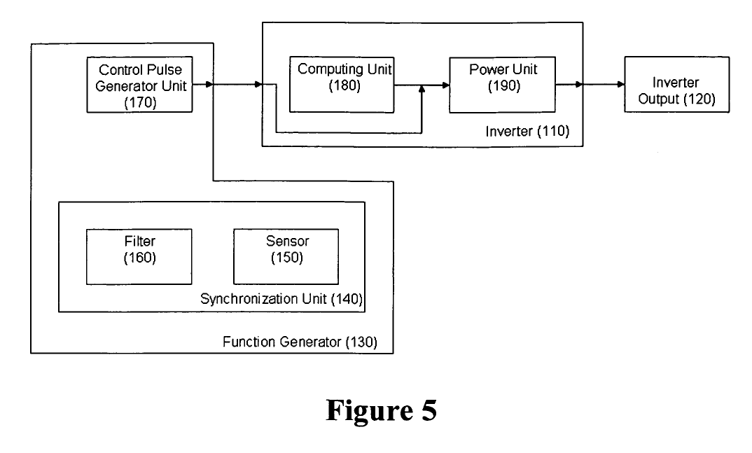

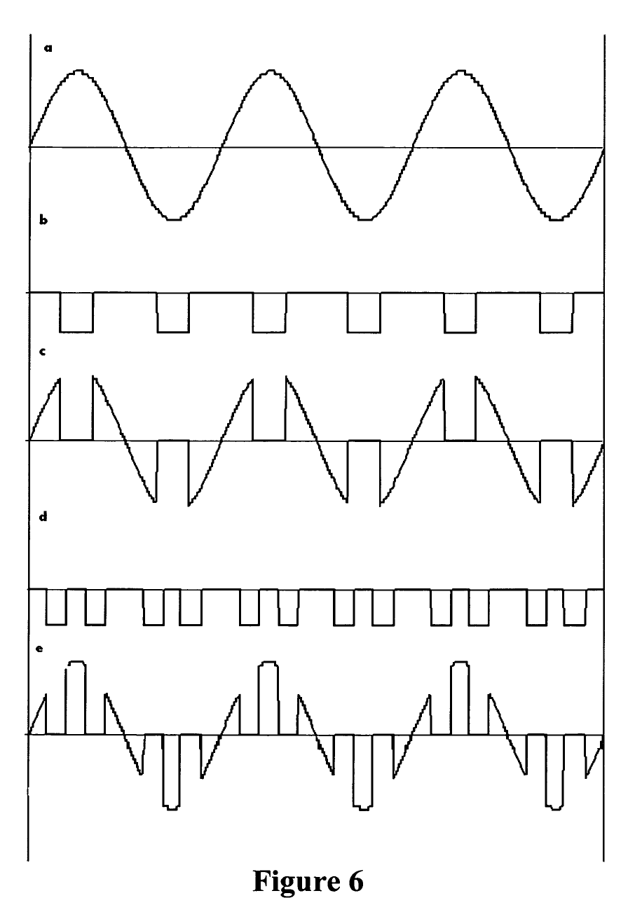

In some embodiments, as illustrated in FIG. 5, the synchronization unit 140 is idle and the control pulse generator unit 170 operates in a self-sustained oscillator mode. Control pulse generator unit 170 provides pulses having a period less than the period of the multi-phase harmonic currents of a specified shape to power unit 190, and computing unit 180 generates a harmonic output control signal. The superposition of pulses of a specified shape and the harmonic output control signal induces the power unit 190 of inverter 110 to generate anharmonic multi-phase currents at the inverter output 120.

While detailed and specific embodiments of the system and method for producing anharmonic multi-phase currents have been described herein, it will be apparent to those skilled in the art that various changes and modifications can be made therein without departing from the spirit and scope of the system and method for producing anharmonic multi-phase currents. Thus, it is intended that the present disclosure cover these modifications and variations provided they come within the scope of any appended claims and/or their equivalents.

What is claimed is:

1. A system for producing anharmonic multi-phase currents comprising:
an inverter, the inverter having an input and an output; and,
a function generator, the function generator capable of sampling the inverter output and generating a control signal, the control signal, when applied to the inverter input, causing the inverter to output anharmonic multi-phase currents.

2. The system of claim 1, wherein the function generator further comprises a low-pass filter, the low-pass filter producing a filtered signal, the filtered signal comprising the harmonic component of the inverter output, and wherein the control signal comprises the superposition of one or more pulses and the filtered signal.

3. The system of claim 2, wherein at least a subset of the pulses are square waves.

4. The system of claim 2, wherein at least a subset of the pulses are triangle waves.

5. The system of claim 2, wherein the period of the control signal is less than the period of the harmonic component of the inverter output.

6. The system of claim 2, wherein the period of the control signal is less than half of the period of the harmonic component of the inverter output.

7. A system for producing anharmonic multi-phase currents comprising:
an inverter, the inverter having an input and an output; and,
a function generator, the function generator capable of generating a control signal, the control signal comprising one or more pulses, the control signal, when applied to the inverter input, causing the inverter to output anharmonic multi-phase currents.

8. The system of claim 7, wherein at least a subset of the pulses are square waves.

9. The system of claim 7, wherein at least a subset of the pulses are triangle waves.

10. The system of claim 7, wherein the period of the control signal is less than the period of the harmonic component of the inverter output.

11. The system of claim 7, wherein the period of the control signal is less than half of the period of the harmonic component of the inverter output.

12. A method for producing anharmonic multi-phase currents, the method comprising:
filtering an inverter output with a low-pass filter to produce a filtered signal, the filtered signal comprising the harmonic component of the inverter output;
generating a control signal, the control signal comprising the superposition of one or more pulses and the filtered signal, the control signal capable of causing an inverter to output anharmonic multi-phase currents; and,
applying the control signal to an inverter input, thereby causing the inverter to produce anharmonic multi-phase currents.

13. The method of claim 12, wherein at least a subset of the pulses are square waves.

14. The method of claim 12, wherein at least a subset of the pulses are triangle waves.

15. The method of claim 12, wherein the period of the control signal is less than the period of the harmonic component of the inverter output.

16. The method of claim 12, wherein the period of the control signal is less than half of the period of the harmonic component of the inverter output.

17. A method for producing anharmonic multi-phase currents, the method comprising:
generating a control signal, the control signal comprising one or more pulses, the control signal capable of causing an inverter to output anharmonic multi-phase currents; and,
applying the control signal to an inverter input, thereby causing the inverter to produce anharmonic multi-phase currents.

18. The method of claim 17, wherein at least a subset of the pulses are square waves.

19. The method of claim 17, wherein at least a subset of the pulses are triangle waves.

20. The method of claim 17, wherein the period of the control signal is less than the period of the harmonic component of the inverter output.

21. The method of claim 17, wherein the period of the control signal is less than half of the period of the harmonic component of the inverter output.
